(19) United States
(12) Patent Application Publication
(10) Pub. No.: US 2009/0181220 A1
(43) Pub. Date: Jul. 16, 2009

(54) BAND OF WINDABLE PLASTIC MATERIAL

(75) Inventor: Ezequiel GIRO AMIGO, Badalona (ES)

Correspondence Address: SUGHRUE MION, PLLC, 2100 PENNSYLVANIA AVENUE, N.W., SUITE 800, WASHINGTON, DC, 20037, US

(73) Assignee: GIRO GH, S.A., Badalona (ES)

(21) Appl. No.: 12/350,699

(22) Filed: Jan. 8, 2009

(30) Foreign Application Priority Data
Jan. 14, 2008 (ES) U 200800048

(51) Int. Cl. B32B 3/10

(52) U.S. Cl. 428/195.1

(57) ABSTRACT

The invention relates to a band of windable plastic material, applicable for the production of bags, such as mesh bags, comprising a plurality of markings, distributed along its length, transparent to visible light and luminescent upon being radiated with ultraviolet or infrared light. According to an embodiment, the band is made up of two superimposed sheets, of which the inner sheet is intended to be applied on a bag, whereas the outer sheet is intended to be exposed outside of the bag, the mentioned markings being printed on the inner face of the outer sheet.

### TECHNICAL FIELD OF THE INVENTION

The present invention relates to a band of windable plastic material, applicable to the manufacture of mesh bags and especially of the type of mesh bags comprising at least one lateral band heat-sealed to the mesh at at least one of its ends.

BACKGROUND OF THE INVENTION

In the manufacture of bags made from flat or tubular mesh, intended to contain preferably fruit and vegetable products, machines fed by a long roll of continuous tubular mesh are often used. These machines open a portion of tubular mesh and on one or on both sides of said portion of tubular mesh apply respective laminar bands of plastic material laterally covering the mesh, which are fed from respective long reels of continuous laminar band.

In each operation cycle of the machine, an end portion of the mesh is cut together with the bands on applied on it, the length of said portion being approximately that of the bag to be produced, and the end of the rest of the mesh is closed, transversely joining the side sheets by heat-sealing. The machine then separates a bag open at its mouth and closed at its bottom, which is transferred to subsequent and successive stations for the filling and closure of its mouth.

These bands normally serve as support for printing information, illustrations or instructions related to the stored product. In order for these prints to be well positioned on each one of the manufactured bags, or in order for the length of all the bags to be the same, the machines incorporate a device stopping the automatic advance of the rolls of the mesh and of the laminar bands by means of the optical detection of markings visible from the outer face of at least one of the two lateral laminar bands. Such optically detectable markings have the serious drawback that they are easily confused with other adjacent marks, indications or markings and can produce errors in the subsequent stopping and cutting, therefore a large part of any mark or marking that could produce such errors must be separated. This implies that they noticeably stand out in the external appearance of the bag and give rise to aesthetically undesired effects, which results in important advertising and/or commercial damage. In the same way, the design of the printed illustrations on the band is highly conditioned precisely to prevent some parts of these illustrations from being confused with the markings triggering the automatic cutting of the mesh.

In addition, when for any reason the user of the machine disconnects the markings detector device and voluntarily changes the length of the bags, for example to increase their capacity, the separation between every two markings of the sheets does not coincide with said new length, thereby the markings appear on the bags in different positions as the operation cycles are carried out, substantially changing the appearance of the bags.

### DISCLOSURE OF THE INVENTION

All the drawbacks mentioned above are overcome in the band of windable plastic material object of the present invention, which is essentially characterized in that it comprises a plurality of markings, distributed along its length, transparent to visible light and luminescent upon being radiated with light outside the visible spectrum, i.e. with ultraviolet or infrared light.

This band is particularly applicable to the manufacture of mesh bags of the type having one or respective bands of plastic material transversely joined to the tubular mesh. Upon passing the mesh together with the band or bands applied on it through the detection field of a detector, the detection of said markings can automatically trigger the operations of stopping and subsequent transverse cutting of the assembly formed by the mesh and the bands which is carried out in the manufacture of this type of bags.

According to another feature of the present invention, the markings are distributed in one or several series, the markings of each series being equal, equidistant from one another and differentially detectable with respect to the markings of the other series.

This feature advantageously allows the user of a machine for the manufacture of mesh bags to be able to choose from more than one length of bag without having to change the band or bands which are applied to the sides of the tubular mesh. The user can programme the machine by pre-selecting the markings triggering with their detection the transverse cutting, being able to choose for that the marking of any one of the series of markings. Although the markings of the rest of the series are located in a central position of the bag, they do not detract from the finish of the bags due to being transparent to visible light.

Furthermore, the user can choose from more than one length of bag without sacrificing the precision that can be obtained when the cutting order is made, automatically, by detecting a marking provided for that purpose one the band. Until now, if the manufacturer disconnected the detector device for detecting the markings to voluntarily change the length of the bags, he or she sacrificed the precision that such markings conferred.

According to another feature of the invention, the band is made up of two superimposed sheets, of which the inner sheet is intended to be applied on a bag, whereas the outer sheet is intended a be exposed outside of the bag, and in that the markings are printed on the inner face of the outer sheet.

According to another feature of the invention, the mentioned inner face of the outer sheet is provided with a print carried out with ink not transparent to visible light, being superimposed onto the markings.

In the sense of the present invention, a band of plastic material also includes bands of compostable plastic material, understanding as such any material that can be subjected to composting, such as for example those comprising modified starch, polylactones, aliphatic polyesters, aliphatic copolyesters, polylactic acid or their derivatives and polycaprolactones.

### BRIEF DESCRIPTION OF THE DRAWINGS

Embodiments of the invention are shown in the attached drawings by way of non-limiting example. In said drawings,

FIG. 1 is a perspective view of a reel of a laminar band according to the invention;

FIGS. 2, 3 and 4 show respective plan views of a piece of the band of the invention in respective embodiments thereof; and

FIG. 5 depicts a section view and a notably enlarged view of the band in question.

### DETAILED DESCRIPTION OF THE DRAWINGS

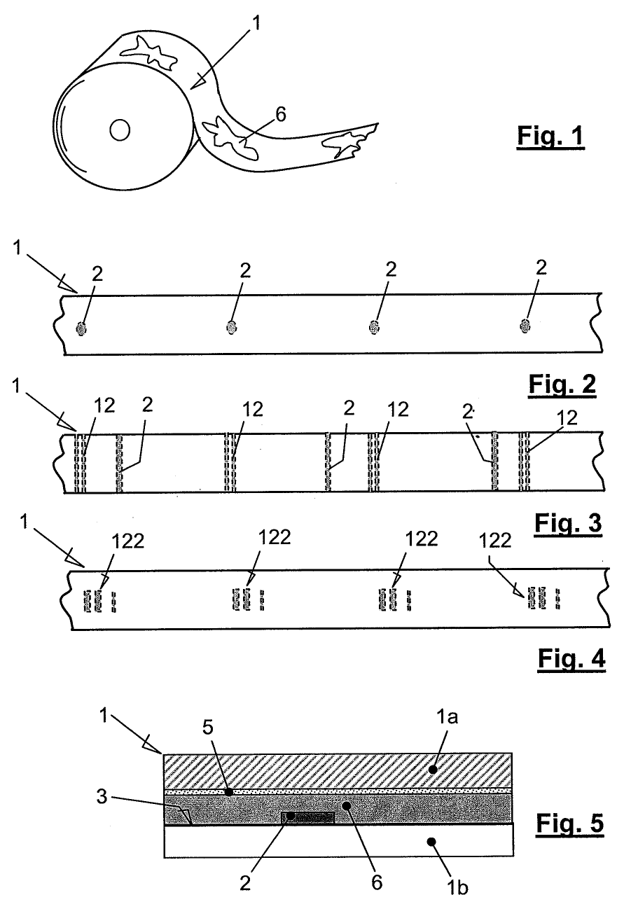

In FIG. 1 of said drawings it can be seen that the band 1 is provided on at least one of its faces with regularly spaced conventional prints 6, which can be informative and/or for advertising.

Furthermore, as is seen in FIGS. 2 to 4, the band 1 is provided according to the invention with a plurality of markings 2, 12 or 122, transparent to light radiations within the spectrum visible to the human eye, suitably distributed along its length and suitable so that, upon being radiated with ultraviolet light, they emit a luminescent reflection capable of activating a sensor that starts up, by way of example, a transverse cutting mechanism 1 for cutting the band.

These markings can be distributed in a single series of markings 2, as is seen in FIG. 2. Likewise, as can be seen in FIG. 3, the markings can be distributed on the band 1 in two series 2, 12 of markings, the markings 2 of one series being able to be different from the markings 12 of the other series in arrangement (different distances between consecutive markings), in makeup (printed with different inks) and/or in configuration (in this embodiment the marking 2 is a single transverse mark and the marking 12 is two consecutive transverse marks).

Naturally, the number of series could also be three or more, without departing from the scope of protection of the invention as a result.

In any case, in a band according to the example of FIG. 3, due to the markings 2 of the first series being different from the markings 12 of the second series, the user can pre-select the type of markings that he/she wishes to trigger the transverse cutting operation of the band 1. When the band 1 is applied on a portion of continuous tubular mesh in a process for the manufacture of mesh bags, the mesh, together with the band or bands will be cut and separated from the rest of the roll of tubular mesh.

Likewise, as shown in FIG. 4, it can be taken into account that the markings 122 could be configured to encode information of the manufacturer for traceability purposes, for example.

In FIG. 5 it can be seen that the band 1 is preferably made up of two superimposed inner la and 1b outer sheets, the latter being provided on its inner face 3 with a print 6 carried out with ink not transparent to visible light. This print 6 can be superimposed onto the markings 2, 12 or 122 without interfering with their subsequent detection.

The inner sheet 1a is intended to be applied on a bag, for example on a tubular mesh, and is firmly adhered on the outer sheet 1b by means of a layer of adhesive 5. In turn, the outer sheet 1b is suitable for being exposed outside of the bag.

Lastly, it should be mentioned that the markings 2, 12 or 122 can even be formed by corporate logos or other types of graphics or business identification, such that as well as serving to trigger operations such as a transverse cutting operation when they are detected, they can also advantageously serve to verify the authenticity of a product and prevent fraudulent copies of thereof.

1. A band (1) of windable plastic material, applicable for the production of bags, comprising a plurality of markings (2, 12, 122), distributed along a length of the band, transparent to visible light and luminescent upon being radiated with ultraviolet or infrared light.

2. The band (1) according to claim 1, wherein the markings are distributed in one or several series, the markings of each series being equal, equidistant from one another and differentially detectable with respect to the markings of the other series.

3. The band (1) according to claim 1, comprising two superimposed sheets, an inner sheet and an outer sheet, of which the inner sheet (1a) is for application on a bag, whereas the outer sheet (1b) is to be exposed outside of the bag, and in that the markings (2, 12, 122) are printed on an inner face (3) of the outer sheet (1b).

4. The band (1) according to claim 3, wherein the inner face (3) of the outer sheet is provided with a print carried out with ink (6) not transparent to visible light, which is superimposed onto the markings (2, 12, 122).

5. The band according to claim 1, configured for application to mesh bags.
